(19) United States
(12) Patent Application Publication
(10) Pub. No.: US 2008/0090562 A1
(43) Pub. Date: Apr. 17, 2008

(54) SYSTEM AND METHOD FOR PROVIDING ADVERTISING USING A COMMUNICATION NETWORK

(76) Inventors: Justin Divis, Huntington Beach, CA (US); Shane Leopard, Maricopa, AZ (US)

Correspondence Address: SCHMEISER OLSEN & WATTS, 18 E UNIVERSITY DRIVE, SUITE # 101, MESA, AZ, 85201, US

(21) Appl. No.: 11/838,179

(22) Filed: Aug. 13, 2007

Related U.S. Application Data
(63) Continuation-in-part of application No. 11/566,592, filed on Dec. 4, 2006.
(60) Provisional application No. 60/742,735, filed on Dec. 5, 2005.
(60) Provisional application No. 60/746,006, filed on Apr. 28, 2006.

(51) Int. Cl. H04Q 7/20

(52) U.S. Cl. 455/422.1

(57) ABSTRACT

A system includes a cellular communication network having a media file storage system and a base-station in communication with each other. A first cellular communication device is in communication with the media file storage system through the base-station. A media file is stored with the media file storage system. The content of the media file is played by the first cellular communication device in response to the first cellular communication device having a predetermined condition.

### CROSS-REFERENCE TO RELATED APPLICATIONS

This application claims priority to U.S. patent application Ser. No. 11/566,592, filed on Dec. 4, 2006, which claims priority to U.S. Provisional Application Nos. 60/742,735 and 60/746,006, filed on Dec. 5, 2005 and Apr. 28, 2006, respectively, all by the same inventors, the contents of all of which are incorporated herein by reference.

### BACKGROUND OF THE INVENTION

1. Field of the Invention

This invention relates to communication networks for cellular phones.

2. Description of the Related Art

The use of personal hand held electronic devices, such as cellular phones, pagers, and personal digital assistants is very widespread. These electronic devices are designed to be carried by a user and are highly portable. The expense of owning a cellular phone is decreasing and they are replacing phones that communicate through land lines. To generate more revenue and attract more customers, the cellular phone industry provides a number of accessories to the cellular phone user.

Examples of cellular phone accessories include tones, such as ring and ring back tones. Tones can be selectively downloaded by the user and stored with his or her cellular phone. A ring tone is what a user hears when someone calls his or her cellular phone and a ring back tone is what the caller hears when calling someone else's cellular phone. The ring and ring back tones generally include specialized rings and songs that play when a call is received. As of yet, however, there are no similar features available for when a person is holding.

### BRIEF SUMMARY OF THE INVENTION

The present invention employs a system with a cellular communication network having a media file storage system and a base-station in communication with each other. A media file is stored with the media file storage system and a first cellular communication device is in communication with the media file storage system through the base-station. The content of the media file is flowed through the base-station and played by the first cellular communication device in response to the first cellular communication device having a predetermined condition, such as a hold condition.

The invention also provides a method of providing a media signal to a phone user. In one embodiment, the method includes establishing communication between first and second cellular communication devices through a base-station of a communication network. The media signal is received with the first cellular communication device in response to the first cellular communication device having the predetermined condition. The media signal is flowed between the base-station and a media file storage system, as well as the base-station and first cellular communication device.

In another embodiment, a method of providing a media signal to a phone user includes determining which cellular communication devices have the predetermined condition. The cellular communication devices have access to one or more media files stored with the media file storage system of the communication network. A media signal is transmitted to the cellular communication devices that have the predetermined condition, wherein the media signal corresponds to a selected one of the media files.

Further features and advantages of the invention will be apparent to those skilled in the art from the following detailed description, taken together with the accompanying drawings.

### BRIEF DESCRIPTION OF THE DRAWINGS

FIG. 1 is a flow chart of a method of providing a media signal to a client phone, in accordance with the invention.

FIG. 2 is a perspective view of a base-station.

FIG. 3 is a flow chart of another method of providing a media signal to a phone user, in accordance with the invention.

FIG. 4 is a block diagram of a communication system, in accordance with the invention, for providing a media signal to a phone user.

FIG. 5 is a block diagram of another communication system, in accordance with the invention, for providing a media signal to a phone user.

FIG. 6 is a flow diagram of a method of providing a media signal to a phone user, in accordance with the invention.

FIG. 7 is a flow diagram of a method of providing a media signal to a phone user, in accordance with the invention.

FIG. 8 is a block diagram of a communication system, in accordance with the invention.

### DETAILED DESCRIPTION OF THE INVENTION

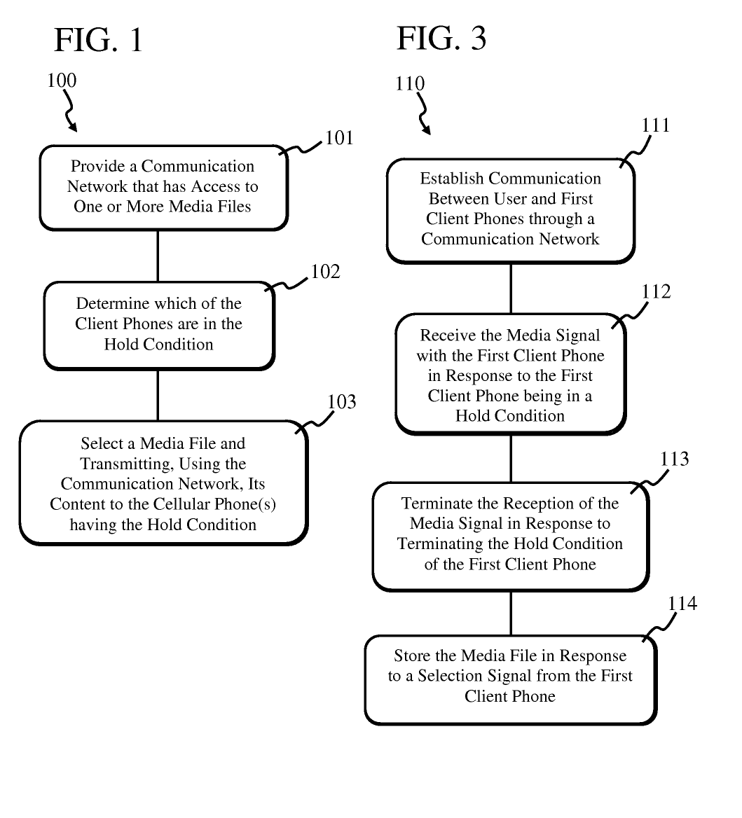

FIG. 1 is a flow chart of a method 100 of providing a media signal to a phone, in accordance with the invention. In this embodiment, method 100 includes a step 101 of providing a communication network that has access to one or more media files. There are several types of communication networks available and they can utilize many different telephone communication methods, such as code division multiple access (CDMA), time division multiple access (TDMA) and global system for mobile communication (GSM). The communication network provides telephone communications between the phones. The communication network can communicate with many different types of phones, such as wired and wireless phones. Wired phones transmit and receive signals through a phone line connected to it, and wireless phones transmit and receive signals wirelessly and are often referred to as mobile and cellular phones.

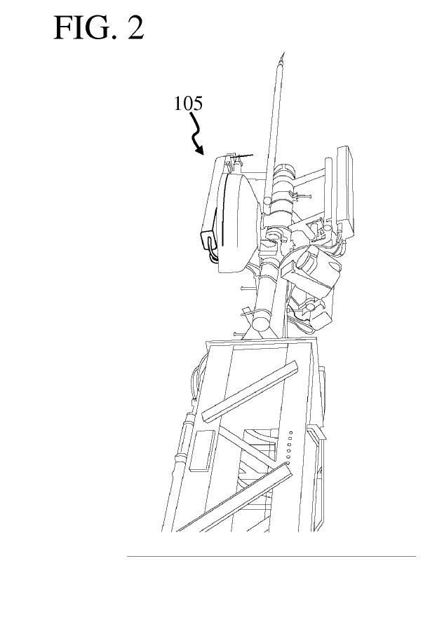

Communication networks that provide communication with wireless phones often include a base-station. The base-station can be of many different types, but it is generally a two-way radio installation that flows communication signals between one or more phones. The base-station and wireless phones each include their own transceiver which is used to transmit and receive the communication signals. An example of a ground base-station is shown in FIG. 2 and more information regarding base-stations and how they operate can be found in U.S. Pat. No. 5,613,211. An example of a satellite base-station is disclosed in U.S. Pat. No. 5,943,324.

Base-stations can be controlled locally or remotely. Locally controlled base-stations often include a base-station cabinet with front panel controls that is used to control its operation. Remotely controlled base-stations can be operated in a number of different ways, such as through control signals sent via wireless and/or land-line communication links.

Base-stations can include many different components. For example, a base-station typically includes an antenna in communication with electronic communication equipment. It also typically includes one or more transceivers for receiving and transmitting various signals, such as the communication signals mentioned above. Digital signal processors are often included to process the communication signals and control electronics are used to control the operation of the base-station. The control electronics can be a computer which operates software. Some base-station components, such as the antenna, are often positioned on a tower so that the base-station can communicate over a larger distance with wireless phones.

In this embodiment, the communication network is generally in communication with one or more client phones and the client phones are in communication with each other through the communication network. The client phones can be of many different types, but here they are wireless phones. In other embodiments, the client phones can be wired phones or combinations of wired and wireless phones. The client phones can be made by many different manufacturers, several of which are known in the art.

In accordance with the invention, the media file(s) are stored with a media file storage system included with the communication network. The media file(s) can be of many different types, such as an audio or video file. The audio file generally includes sound information and the video file generally includes visual as well as sound information. An example of an audio file is an MP3 file and an example of video files are WMV, MPEP and AVI. These media files include information stored digitally so the information is readily accessible to a computer, such as the computer included with the base-station. The content of the media file corresponds to a media signal S_{Media}, which can be of many different types. However, media signal S_{Media} is generally one that can be transmitted wirelessly by the communication network and received and played by the client phones. It should be noted that the media file is generally converted to a corresponding media signal by a transceiver included with the media file storage system, as will be discussed in more detail below.

The media file storage system can be of many different types, but it generally operates the same or similar to a voice mail system. Examples of voice mail systems are disclosed in U.S. Pat. Nos. 5,802,466, 5,884,160 and 6,032,039. These voice mail systems can be used, or modified for use, as the media file storage system. The media file storage system allows the media file(s) to be stored externally to the client phones and the base-station so they are accessible to the communication network. The media file storage system generally includes memory for storing the media file(s). There are many different types of memory that can be used, such as magnetic memory and semiconductor memory. An example of magnetic memory is a hard drive and an example of semiconductor memory is FLASH memory.

The media file(s) are stored externally to the client phone for many different reasons. One reason is that a media file generally requires a large amount of memory, which is not available on most cellular phones. Another reason is that the operator of the media file storage system can control the flow of the media files, as will be discussed in more detail below.

The media file can include many different types of information, such as a voice message, music, news, advertisements or any other audible information. Media file can also correspond to a radio station signal. In some embodiments, the client phone allows its user to record a message, which is used as the media file. The recordation of the message can be facilitated with the use of many different types of electronic devices, such as a computer, music player and/or a microphone. In this way, the user has the ability to create, download and upload his or her own personalized media file.

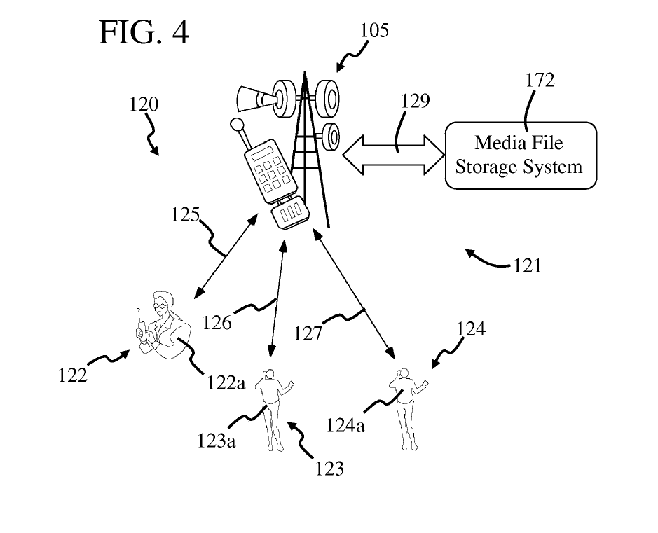

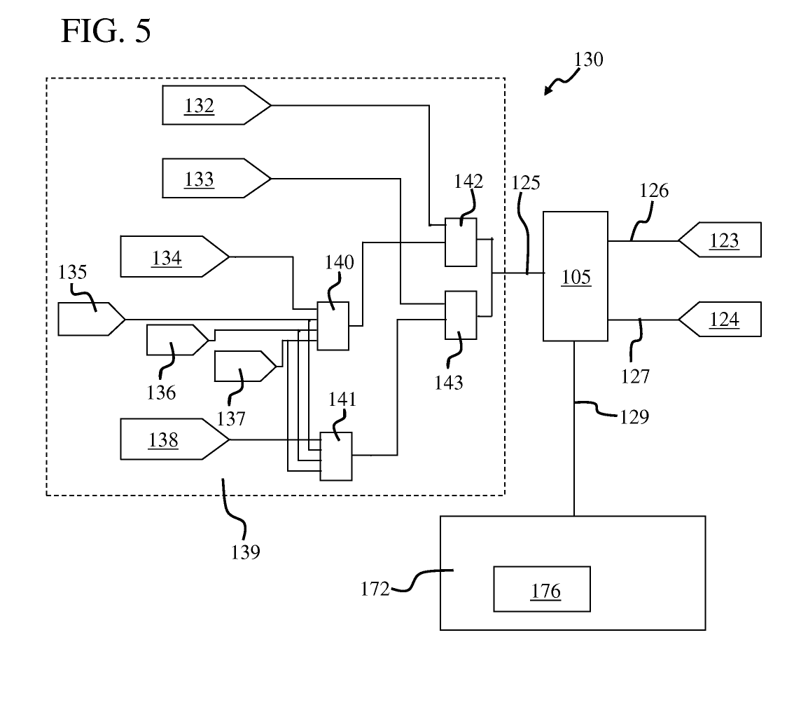

The media files can be prestored or they can be uploaded and stored using the client phone or the base-station. As discussed in more detail with FIG. 4, the media files are stored using the base-station and, as discussed in more detail with FIG. 5, the media files are stored using a cellular phone. A number of prestored media files can exist and one or more of them can be selected by the user of the client phone. In some situations, access to the stored media files is provided in exchange for consideration, such as payment, and, in other situations, it is provided for no consideration. Advertisers can also provide consideration to have their own media file stored with the media file storage system so the user of the client phone has the option of selecting it. Also, the user can purchase recordings, such as songs, for the purpose of having the option to store those purchased recordings with the media file storage system.

The creation, downloading and uploading of the personalized media file with the media file storage system can be facilitated with the software that operates the computer of the base-station and/or the software used to operate the telephone communication method of the communication network. For example, the user can upload media files to the communication network through an internet connection established with the base-station computer or a computer included with the media file storage system. The media file can also be uploaded by the user using his or her cellular phone. Hence, computer software is used to allow the communication network to store, retrieve and transmit the media signals with the media file storage system.

A client phone can have many different conditions of operation. For example, when it is turned on, it typically has active, inactive and hold conditions. In the active condition, a communication link is established between it and at least one other phone through the communication network. It should be noted that signals can flow through a communication link when it is established so people can talk to each other. In the inactive condition, a communication link is not established between the client phone and any other phones. Signals cannot flow through a communication link when it is not established so people cannot talk to each other. In some situations, the communication link is often one or more communication links connected together which allow signals to flow between the communication network and the client phones when the links are established. The number of communication links and how they are connected together is generally determined by the communication network.

In the hold condition, the communication link is established, but the ability to flow signals through it is restricted, which can be done in many different ways. For example, in one situation, a communication link between two client phones is established so they are both in their active conditions. The user of the first client phone then establishes the second client phone in the hold condition so the communication link between the first and second client phones is still established, but the flow of signals between them is restricted. In this way, the first and second client phones are still connected to the communication network, but not to each other.

The hold condition is useful when the first client phone has a communication link established with the second client phone, but receives an indication that it is receiving another call from another phone, such as a third client phone. The user of the first client phone can initiate the hold condition for the second client phone and establish a communication link with the third client phone. The user of the second client phone “holds” while the user of the first client phone communicates through the other communication link with the user of the third client phone.

Method 100 includes a step 102 of determining which of the client phones are in the hold condition. A client phone can be moved to the hold condition in many different ways. For example, its hold condition can be established in response to it receiving a hold signal S_{H}. Hold signal S_{H} can be provided from many different sources, such as the communication network and/or another client phone. The communication link with the holding client phone can then be reestablished so that it is in its active condition. In this way, a client phone is moved between active and hold conditions. It should be noted that in some situations, more than one client phone can have a hold condition.

The communication link between the client phone and another phone can also be terminated. The communication link can be terminated in many different ways, such as by providing it with a termination signal S_{T}. Signal S_{T} can be provided from many different sources, such as the communication network and/or another client phone.

In a step 103, a media file stored with the media file storage system is selected and its content is transmitted as a corresponding media signal to the client phone(s) having the hold condition. The content of the media file is transmitted as media signal S_{Media}, which is a signal that includes information that is received by the client phone and converted to sound that is outputted by the client phone. Hence, the content of the media file corresponding to media signal S_{Media} is played when the client phone is moved from an active condition to a hold condition. The playing of the content of media signal S_{Media} is terminated in response to terminating the hold condition of the client phone. In this way, the output of the media file content is terminated in response to an indication that the hold condition of client phone 103 is terminated. It should be noted that the media signal generally flows between the media file storage system and the base-station, as well as between the base-station and the client phone(s).

The media file can be selected in many different ways. For example, in some situations, the media file is selected so that the same one is transmitted to all the client phones having the hold condition. In other situations, the media file is selected in response to a parameter of the client phone. The parameter of the client phone can correspond to many different types of information.

For example, the parameter can be the phone number of the client phone or the area code. This is useful so a media file corresponding to a geographical region can be selected. This is also useful so that personal information corresponding to the user of the client phone can be used to select the media file. The personal information can be obtained from the phone records of the user. The user of the client phone is generally its owner, although it can be somebody else in some situations. For example, the phone can belong to a company and the user can be an employee of the company. In another example, the phone can belong to an adult and the user can be a relative of the adult.

The personal information can be of many different parameters, such as age, birth date, sex, medical history, number of children and marital status, among others. For example, media signal S_{Media} can be selected in response to an age parameter from the phone records corresponding to the user. This is useful so a media file corresponding to an advertisement appealing to a particular age group can be selected. If the age parameter from the personal information indicates that the owner of the client phone is a teenager, then the media signal can be an advertisement that is likely to be appealing to teenagers. If the parameter from the personal information indicates that the owner of the client phone is a mother of an infant, then the media signal can be an advertisement that is likely to be appealing to mothers having infants.

The parameter can correspond to a location indication, such as from a global positioning system. This is useful so a media file corresponding to the geographical location of the user can be selected. The parameter can also correspond to the time (i.e. 7:30 am or 1:15 pm) at the location of the client phone. This is useful so a media file corresponding to a particular time of day can be selected. For example, during morning hours, the selected media file can include an advertisement for lunch at a restaurant. Further, during afternoon hours, the media file can include an advertisement for dinner at a restaurant.

In some embodiments, the parameter corresponds to that of a business wherein the client phones are used by employees of the business. For example, the media files can be customized to provide advertising or messages for this particular business. This is often the case in construction management or sales businesses, for example. Method 100 provides these businesses with the ability to create customized business hold messages on each of their employees' cellular phones. Method 100 also allows these businesses to play special messages or advertisements to customers on hold regardless of whether the employee is using their cellular phone or a land line.

The advertisement can be selected based on time zones too. This is useful to provide national coverage for a company having locations in different time zones. For example, a national chain restaurant can have a media file corresponding to its advertisement played in the late afternoon in the Eastern, Central, Mountain and/or Pacific Time zones of the United States, to attract customers for dinner. The national chain restaurant can also have its media file advertisement played in predetermined states and/or cities throughout these time zones.

In some embodiments, advertising time slots are sold to advertisers. The advertisers can be of many different types, such as individuals and businesses. The businesses can be of many different types, such as marketing firms that market products, political messages and/or services. Advertisers wanting to broadcast a particular hold advertisement can purchase the time slot from the cellular phone provider. Advertisers can purchase the time slot so that their advertisement is played for users on hold within a local and/or national wireless communication network. Advertising can also be done on a local, national or world wide level. Cellular phone providers also have the ability to partner with other cellular phone providers in order to allow advertisers to purchase advertising on multiple provides which and reach a larger audience.

Hence, an advantage of method 100 is that is allows a large number of cellular phone users to be exposed to advertisements when holding. This is useful so that advertising and/or marketing firms can expose a larger number of cellular phone users to advertisements and generate more revenue.

An advantage of the communication network of method 100 is that it is not necessary to modify the client phones it provides communications for, although they can be in some embodiments. Instead, the communication network is modified to give it access to the media files stored with the media file storage system. In this way, the operation of the communication network can be implemented using existing cellular phones. It should be noted that computer software is typically used to allow the communication network to store, retrieve and transmit the media signals with the media file storage system. This can be the same software currently in use to implement the telephone communication methods generally used.

FIG. 3 is a flow chart of a method 110 of providing a media signal to a phone user, in accordance with the invention. In this embodiment, method 110 includes a step 111 of establishing communication between a user phone and a first client phone through a communication network. Method 110 also includes a step 112 of receiving the media signal with the first client phone in response to the first client phone being in a hold condition. The hold condition of the first client phone can be established in many different ways, but here it is established in response to it receiving a hold signal. In accordance with the invention, media signal S_{Media} is determined in response to the parameter of the user and/or first client phones. Media signal S_{Media} corresponds to a media file stored with a media file storage system of the communication network.

It should also be noted that method 110 can include many other steps. For example, in some embodiments, method 110 includes a step 113 of terminating the reception of the media signal in response to terminating the hold condition of the first client phone. The hold condition of the first client phone can be terminated in many different ways, but here it is terminated in response to it receiving termination signal S_{T}.

Method 110 can also include a step 114 of storing the media file using the first client phone. The first client may want to store the media file because in some situations, he or she may want to review the media signal S_{media}. For example, if the user terminates the hold position and thus terminates S_{media} while first client is receiving S_{media}, first client may want to store the media file for later review. The media file can be stored by first client in many ways. For example, the media file can be stored by first client onto his or her phone, or onto a media file storage system to which he or she has access.

Method 110 can also include establishing, through the communication network, communication between the user and first client phones and a second client phone, such as in a “conference call”. It should be noted that one or more client phones can be in the hold condition and provided with the same or different media signals and the illustration of two client phones here is for simplicity.

The first and second client phones can receive and output the same or different media signals when they are in the hold condition. This feature is useful because it allows the user of the user phone to select the media signal played for the users of first and second client phones when they are in their hold conditions. This is another way in which the playing of the media signals can be customized in response to the parameter of the client phone(s).

FIG. 4 is a block diagram of a system 120, in accordance with the invention. In this embodiment, system 120 includes a communication network 121, which generally includes a base-station 105 (FIG. 2), and provides telephone communications. Communication network 121 can be of many different types, but in this embodiment it operates as a cellular communication network. A cellular communication network includes one or more wireless communication links. However, it should be noted that a cellular communication network can also include one or more wired communication links.

In this embodiment, a user phone 122 and a client phone 123 are in communication with each other through communication links established with communication network 121. User phone 122 is being used by a user 122a and client phone 123 is being used by a user 123a. Here, user phone 122 is in communication with base station 105 with a communication link 125 and client phone 123 is in communication with base station 105 with a communication link 126. Base station 105 connects communication links 125 and 126 together so signals can flow between phones 122 and 123 and users 122a and 123a can talk to each other.

Phones 122 and 123 can be of many different types, but in this embodiment they are cellular phones. In other embodiments, phone 122 and/or phone 123 can be a wired phone. Phones 122 and 123 can be made by many different manufacturers, several of which are known in the art. Phones 122 and 123 can have many different conditions of operation, which were discussed in more detail above. For example, when phones 122 and 123 are turned on, they can have active, inactive and hold conditions. It should be noted that phones 122 and/or 123 can be replaced with a video device capable of receiving media signal S_{Media} when it corresponds to a video file. The video device is capable of playing the content of the video file.

Client phone 123 can be moved to its hold condition in many different ways. For example, its hold condition can be established in response to it receiving a hold signal S_{H}, which flows through communication link 126. Signal S_{H} can be provided from many different sources, such as communication network 121 and/or user phone 122. User phone 122 can then reestablish the communication link with client phone 123 so that client phone 123 is in its active condition. In this way, client phone 123 is moved between active and hold conditions.

User phone 122 can also terminate the communication link between it and client phone 123. The communication link can be terminated in many different ways. In one way, a termination signal S_{T} is provided to client phone 123 through communication link 126. Signal S_{T} can be provided from many different sources, such as communication network 121 and/or user phone 122.

In the hold condition, communication link 126 is established, but the ability to flow signals through it is restricted. The ability to flow signals can be restricted in many different ways. For example, in one situation, a communication link between phones 122 and 123 is established so that phone 123 is in its active condition. User 122a then establishes phone 123 in the hold condition so the communication link between phones 122 and 123 is still established, but the flow of signals between them is restricted. In this way, phones 122 and 123 are still connected to communication network 121, but not to each other.

The hold condition is useful when phone 122 has a communication link established with phone 123, but receives an indication that it has received another call from another phone, such as a client phone 124 being used by a user 124a. User 122a can initiate the hold condition for client phone 123 and establish a communication link 127 with client phone 124. User 123a “holds” while user 122a communicates through the other communication link with user 124a.

In this embodiment, media signal S_{Media} is provided to client phone 123 in response to it being in its hold condition. In accordance with the invention, media signal S_{Media} flows from a media file storage system 172 to base-station 105 through a communication link 129. Media signal S_{Media} flows from base-station 105 to client phone 123 through communication link 126. In particular, media signal S_{Media} flows from base station 105 to client phone 123. Client phone 123 receives signal S_{Media} and outputs it so that user 123a can hear it. In this way, the content of the media file corresponding to media signal S_{Media} is played when client phone 123 is moved from an active condition to a hold condition. Further, media signal S_{Media} is terminated in response to terminating the hold condition of client phone 123. In this way, the output of the media file content is terminated in response to an indication that the hold condition of client phone 123 is terminated.

Media signal S_{Media} can be of many different types, but it is generally one that can be transmitted by communication network 121 and received and played by client phone 123. Hence, media signal S_{Media} is generally a signal that can be flowed through the communication link(s) established by communication network 121. Further, signal S_{Media} is generally one that can be stored with media file storage system 172. For example, media signal S_{Media} can be a media file, of which there are many different types known in the art, such as an MP3 file. These media files generally include information stored digitally.

As mentioned above with FIG. 1, computer software is typically used to allow a communication network, such as network 121, to store, retrieve and transmit the media signals. This can be the same software currently in use to implement telephone communication method, such as CDMA, TDMA and GSM. For example, the software controls the flow of the hold and termination signals.

Media signal S_{Media} can include many different types of information, such as a voice message, music, news, advertisements or any other audible information. In some embodiments, user phone 122 allows its user to record a message, which is used as media signal S_{Media}. The recordation of the message can be facilitated with the use of many different types of electronic devices, such as a computer, music player and/or a microphone. In this way, the user has the ability to create, download and upload his or her own personalized media file.

The creation, downloading and uploading of the personalized media file can be facilitated with the software mentioned above. Alternatively, the user can upload messages to communication network 121 through an internet connection. Also, the user can purchase recordings, such as songs, for the purpose of having the option to use those purchased recordings as media signal S_{Media}.

The media files can be prestored or they can be uploaded and stored by user phone 122 with media file storage system 172 through communication links 125 and 129. A number of prestored media files can exist and one or more of them can be selected by the user of phone 122. Advertisers can also pay to have their own media file prestored with communication network 121, so that user 122a has the option of selecting it using phone 122.

In some embodiments, media signal S_{Media} is stored in an account corresponding to phones 122 or 123 that is accessible to media file storage system 172. This account can have one or more media files associated with it, wherein each media file corresponds to a different media signal. The media signal transmitted to client phone 123 is selected from the media file(s). It should be noted that one media file can be played or they can be played sequentially. The media signal can be selected in many different ways, such as with a selection signal S_{Select}.

In one embodiment, user phone 122 provides selection signal S_{Select} to media file storage system 172 through communication links 125 and 129 and the media file is transferred to his or her account. The content of the selected media file is then transmitted to user phone 123 through communication links 126 and 129 when phone 123 is in its hold condition. The account of user phone 122 can be billed for this service and for access to the media file(s). In this way, the media signal is selected in response to user phone 122.

In another embodiment, a third party account provides a selection signal that corresponds with the account of client phone 123. In some embodiments, the third party account is that of an advertising or marketing firm and is used by them to expose a number of cellular phone users to advertisements when they are “holding”. A media file is selected based on information corresponding to the account of client phone 123. The content of the selected media file is then transmitted to user phone 123 as described above. The third party account can be billed for this service and for access to the media file(s). In this way, the media signal is selected in response to client phone 123. The selection signal can correspond with the account of client phone 123 in many different ways, as will be discussed in more detail presently.

In this embodiment, media signal S_{Media} is determined in response to the parameter of user phone 122 and/or client phone 123. The parameter of phones 121 and 122 can be determined in many different ways, such as through their corresponding phone numbers and/or phone records. The parameter of user phone 122 and 123 can be used to determine information about their users. The user of phones 122 and 123 are generally the person to whom the phone belongs too, although it can be somebody else. For example, the phone can belong to a company and the user can be an employee of the company. In another example, the phone can belong to an adult and the user can be a relative of the adult.

FIG. 5 is a block diagram of a communication system 130, in accordance with the invention. In this embodiment, communication system 130 includes a user phone 139 which can establish a communication link with client phones 123 and 124 through base-station 105. It should be noted that one or more client phones can be included in system 130, but two are shown here for illustrative purposes.

User phone 139 has several options available when communicating with more than one client phone. In a first option, user phone 139 establishes a conference call with both client phones 123 and 124. In a second option, user phone 139 establishes an active condition with one of client phones 123 and 124 and a hold condition with the other one. In a third option, user phone 139 establishes a hold condition with both client phones 123 and 124.

User phone 139 selects which of client phones 123 and 124 is provided with the active and hold conditions. For example, in response to the user of phone 139 pressing a client selection keypad button 132, a multiport switch 142 allows base-station 105 to connect client phone 123 to phone 139. In this way, phone 123 is in its active condition and communication links 125 and 126 are established. Similarly, in response to the user of phone 139 pressing a client keypad button 133, a multiport switch 143 allows base-station 105 to connect client phone 124 to user phone 139. In this way, phone 124 is in its active condition and communication links 125 and 127 are established. Further, client phone 123 is moved from its active to hold condition by deactivating client selection keypad button 132 and client phone 124 is moved from its active to hold condition by deactivating client selection keypad button 133.

In this embodiment, the user of phone 139 has the option of providing client phones 123 and/or 124 with a media signal in response to one or both of them being in a hold condition. In accordance with the invention, the media signal is stored with media file storage system 172, which is in communication with base-station 105 through communication link 129. In this particular embodiment, the media signal is stored as a media file in a register included with media file storage system 172.

In this embodiment, the media file can also be stored with phone 139. For example, the media file can be transmitted to and from media file storage system 172 to phone 139 through base-station 105 and communication links 125 and 129. In this embodiment, phone 139 includes registers 135, 136 and 137 which can be used to store media files corresponding to media signals SMedia₁, SMedia₂ and SMedia₃, respectively. Here, media signals SMedia₁, SMedia₂ and SMedia₃ correspond to different media signals, although they can be the same media signals in other examples. It should be noted that phone 139 generally includes one or more registers, but three are shown here for illustrative purposes.

In some situations, the user of phone 139 can record his or her own media signal using an electronic device, such as a PC, I-Pod®, MP3 Player, or microphone, and store it using the register(s). The user can also allow phone 139 to utilize radio stations for his or her media signal, such as many land lines do. The media signals can be stored in many different formats, such as raw data or formatted data (MP3, for example). The registers can include many different types of memory, such as FLASH memory, and additional circuitry (not shown) is often included with phone 139 to control and process the flow of data between the registers and communication link 125.

Client phones 123 and 124 can be provided with the same or different media signals. To select a particular media signal, the user of phone 139 activates client message selection keypad button 134 and/or 138, then selects one of registers 135, 136 and 137. The selected register outputs its corresponding media file through a corresponding routing switch 140 and 141. If client phone 123 is selected, the media signal corresponding to that media file flows through routing switch 140 and multiport switch 142 and through base-station 105 to client phone 123. In this way, the media signal flows through communication links 125 and 126. If client phone 124 is selected, the media signal corresponding to that media file flows through routing switch 141 and multiport switch 143 and through base-station 105 to client phone 124. In this way, the media signal flows through communication links 125 and 127.

It should be noted that the media signals stored with registers 135, 136 and 137 can be transmitted to media file storage system 172 and stored with storage system 176. Storage system 176 can be any system for storing a media file, such as a computer hard drive. The media signals are transmitted to media file storage system 172 through base-station 105 and communication links 125 and 129.

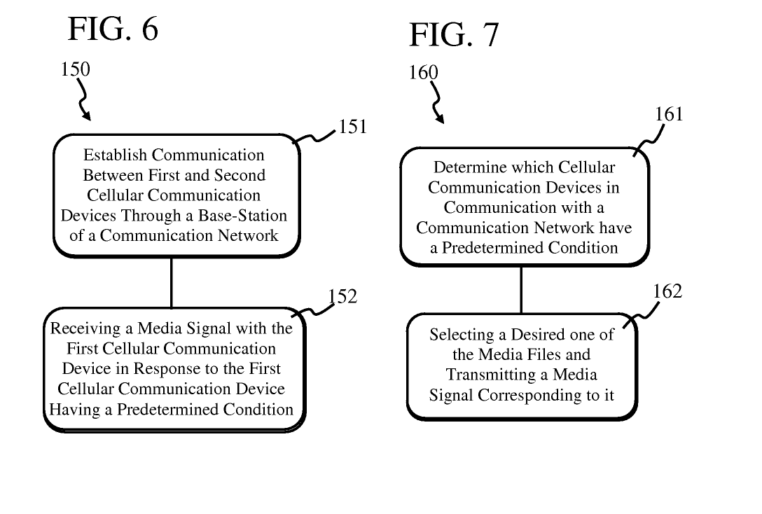

FIG. 6 is a flow diagram of a method 150 of providing a media signal to a phone user, in accordance with the invention. In this embodiment, method 150 includes a step 151 of establishing communication between first and second cellular communication devices through a base-station of a communication network. The cellular communication devices can be of many different types, such as the phones discussed in more detail above. Method 150 includes a step 152 of receiving the media signal with the first cellular communication device in response to the first cellular communication device having a predetermined condition. The predetermined condition is determined in response to a parameter of the first or second cellular communication devices.

In accordance with the invention, the media signal is stored as a media file with a media file storage system. The content of the media file is converted to the media signal with a transceiver. The media signal is flowed between the first cellular communication device and the media file storage system through a base-station. In particular, the media file flows from the media file storage system to the base-station and from the base-station to the first cellular communication device.

It should be noted that method 150 can include many other steps. For example, in some embodiments, method 150 includes a step of terminating the flow of the media signal in response to a termination signal provided by the first cellular communication device. The termination signal flows between the first cellular communication device and the media file storage system through the base-station.

In some embodiments, method 150 includes a step of restricting the flow of the media signal in response to a restriction signal provided by the first cellular communication device. The restriction signal flows between the first cellular communication device and the media file storage system through the base-station. In some embodiments, method 150 includes a step of selecting the media signal from a plurality of media signals stored with the media file storage system. The media signal is selected in response to a selection signal flowed between the first cellular communication device and media file storage system through the base-station. In these embodiments, method 150 can include a step of determining the number of times the media signal has been selected. This is useful to determine the usage of the media files.

FIG. 7 is a flow diagram of a method 160 of providing a media signal to a phone user, in accordance with the invention. In this embodiment, method 160 includes a step 161 of determining which cellular communication devices in communication with a communication network have a predetermined condition. In accordance with the invention, the communication network has access to one or more media files stored with a media file storage system.

If desired, method 160 can include a step of storing the media file(s) with the media file storage system. The media file(s) can be stored with the media file storage system in many different ways. For example, they can be transmitted to the media file storage system through the base-station or they can be uploaded thereto through an Internet connection.

Method 160 includes a step 162 of selecting a desired one of the media files and transmitting a media signal corresponding to it. The media file is selected in response to a parameter of the cellular communication device. The media signal is transmitted to the cellular communication devices that have the predetermined condition. Step 162 of transmitting the media signal generally includes transmitting it from the media file storage system to a base-station of the communication network. Step 162 of transmitting the media signal generally includes transmitting it between the base-station and the cellular communication device.

It should be noted that method 160 can include many other steps. For example, in some embodiments, method 160 includes a step of terminating the transmission of the media signal to the cellular communication devices that no longer have the predetermined condition. The transmission of the media signal can be terminated in many different ways, such as with termination signal S_{T}. In this way, the phone user can terminate the transmission of the media signal and “opt out” of being exposed to it. Termination signal S_{T} generally flows between the cellular communication devices and the media file storage system through the base-station. In these embodiments, method 160 can include a step of playing the media signal with the cellular communication devices that have the predetermined condition.

In some situations, the user can be exposed to the media signal and then go to a web site to opt out. In other situations, the user can be exposed to the media signal and then receive a coupon corresponding to the media signal. The user can also have his or her cellular phone services fee reduced in response to being exposed to the media signal. Further, after being exposed to the media signal, the user can choose to have more information sent to him or her. The information can be sent in many different ways, such as by e-mail, mail, voice mail and text messaging.

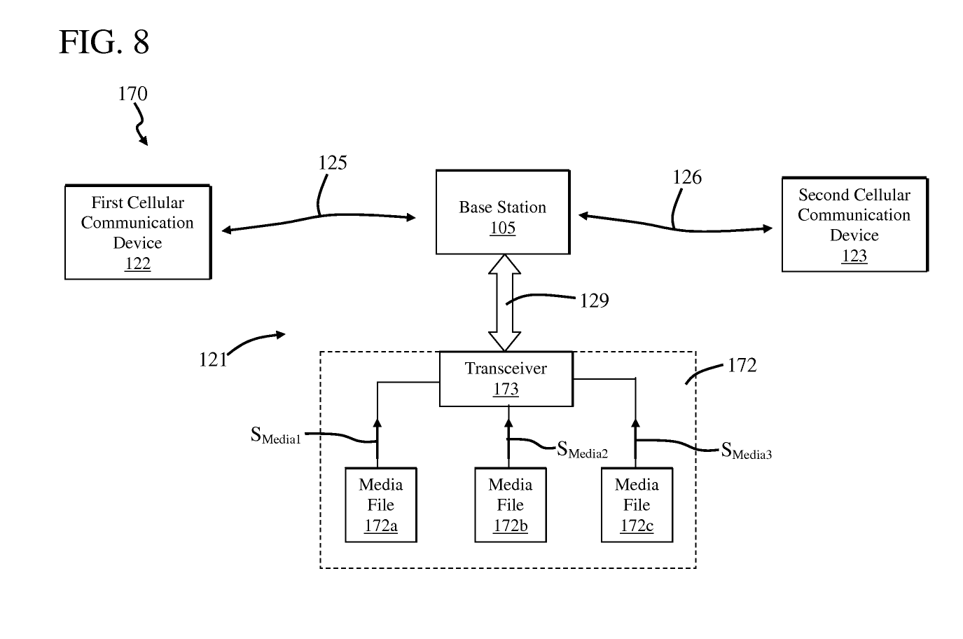

FIG. 8 is a block diagram of a system 170, in accordance with the invention. In this embodiment, system 170 includes communication network 121 having media file storage system 172 and base-station 105. System 170 includes first cellular communication device 122 in communication with media file storage system 172 through base-station 105. A plurality of media files 172a, 172b and 172c are stored with media file storage system 172.

In accordance with the invention, one of media files 172a, 172b and 172c is selected in response to selection signal S_{Select} Selection signal S_{Select} is generally flowed to media file storage system 172 from base-station 105 through communication link 129. In this way, a media file is selected from a plurality of media files stored with a media file storage system.

The content of the selected media file is played by cellular communication device 122 and/or 123 in response to them having a predetermined condition, such as a hold condition. The hold condition can be provided to devices 122 and 123 with hold signal S_{H}. The content of the selected one of media files 172a, 172b and 172c flows between media file storage system 172 and base-station 105. The content of the selected one of media files 172a, 172b and 172c flows between base-station 105 and the cellular communication device having the predetermined condition. It should be noted that media signals S_{Media1}, S_{Media2} and S_{Media3} are transmitted and received by a transceiver 173 included with media file storage system 172.

In some situations, the playing of the selected one of media files 172a, 172b and 172c is terminated in response to an indication from first cellular communication device 122. The termination indication is provided by termination signal S_{T}, which flows between first cellular communication device 122 and media file storage system 172 through base-station 105.

In some situations, the playing of the content of the selected one of media files 172a, 172b and 172c is prevented in response to an indication from first cellular communication device 122. The prevention indication is provided by a prevention signal S_{P}, which flows between first cellular communication device 122 and media file storage system 172 through base-station 105.

While particular embodiments of the invention have been shown and described, numerous variations and alternate embodiments will occur to those skilled in the art. Accordingly, it is intended that the invention be limited only in terms of the appended claims.

1. A system, comprising:
a cellular communication network having a media file storage system and a base-station in communication with each other;
a first cellular communication device in communication with the media file storage system through the base-station; and
a media file stored with the media file storage system, the content of the media file being played by the first cellular communication device in response to the first cellular communication device having a predetermined condition.

2. The system of claim 1, wherein the content of the media file is flowed between the media file storage system and base-station.

3. The system of claim 1, further including a plurality of media files stored with the media file storage system.

4. The system of claim 1, further including a second cellular communication device, wherein playing of the content of the media file is terminated in response to an indication from the second cellular communication device.

5. The system of claim 4, wherein the indication is provided by an indication signal flowed between the first and second cellular communication devices and the base-station.

6. The system of claim 4, wherein the playing of the content of the media file is prevented in response to an indication signal flowed from the second cellular communication device.

7. A method of providing a media signal to a phone user, comprising:
establishing communication between first and second cellular communication devices through a base-station of a communication network; and
receiving the media signal with the first cellular communication device in response to the first cellular communication device having a predetermined condition, the media signal being flowed between the base-station and a media file storage system.

8. The method of claim 7, further including flowing the media signal between the base-station and first cellular communication device.

9. The method of claim 7, wherein the predetermined condition is determined in response to a parameter of the first or second cellular communication devices.

10. The method of claim 7, further including terminating the flow of the media signal in response to a termination signal provided by the first cellular communication device.

11. The method of claim 7, further including restricting the flow of the media signal in response to a restriction signal provided by the first cellular communication device.

12. The method of claim 7, further including selecting the media signal from a plurality of media signals stored with the media file storage system.

13. The method of claim 12, wherein the media signal is selected in response to a selection signal flowed between the first cellular communication device and media file storage system and through the base-station.

14. The method of claim 12, further including determining the number of times the media signal has been selected.

15. A method, comprising:
determining which cellular communication devices have a predetermined condition, the cellular communication devices having access to one or more media files stored with a media file storage system of a communication network; and
transmitting a media signal to the cellular communication devices that have the predetermined condition, the media signal corresponding to a selected one of the media files.

16. The method of claim 15, wherein the step of transmitting the media signal includes transmitting it from a base-station of the communication network.

17. The method of claim 15, wherein the step of transmitting the media signal includes transmitting it between a base-station of the communication network and the media file storage system.

18. The method of claim 15, wherein the media signal is selected in response to a parameter of the cellular communication device having the predetermined condition.

19. The method of claim 15, further including storing the media file(s) with the media file storage system.

20. The method of claim 19, further including flowing the media file(s) from a base station of the communication network to the media file storage system.
